(19) United States
(12) Patent Application Publication
(10) Pub. No.: US 2016/0007777 A1
(43) Pub. Date: Jan. 14, 2016

(54) Travel Pillow

(71) Applicants: Lisa Kyung Rim Gang, Bingen, WA (US); Robert Allen Abercrombie, Bingen, WA (US)

(72) Inventors: Lisa Kyung Rim Gang, Bingen, WA (US); Robert Allen Abercrombie, Bingen, WA (US)

(21) Appl. No.: 14/329,144

(22) Filed: Jul. 11, 2014

(51) Int. Cl. A47G 9/10; A44B 17/00; B60N 2/48; A44B 99/00; A44B 13/00; A44B 19/00; A44B 1/00

(52) U.S. Cl. CPC A47G 9/1009; A44B 19/00; A44B 17/00; A44B 1/00; A44B 99/00; A44B 13/00; A47G 9/1027; A47G 9/1036; A47G 9/1081; B60N 2/4879; A47G 2009/1018

(57) ABSTRACT

The present invention discloses a C-shaped or an O-shaped travel pillow intended to be worn fastened around the user's neck haying a thinner base collar that is cushioned but stiff and completely closeable and overlapping around the person's neck, attached to a shorter softer raised and further cushion or pillow fixed to the top side of the base collar that can be adjusted to accommodate the person's coin as needed. The top of the peripheral walls of the base are attached to a raised cushion or pillow that is fuller and softer than the base. The base or collar is also cushioned but considerably stiffer and with longer ends than the top pillow, allowing the base collar of the invention to be fitted around the person's neck and closed completely underneath the person's chin to hold the person's neck immobile. Furthermore, the pillow top raised cushion is thicker than the sides, providing even more cushioning, support and stability for the person's head by easily adapting, to the shape of the headrest, seat or chair or the movement thereof.

### FIELD OF THE INVENTION

This invention relates to pillows, and more particularly to a travel pillow.

### DISCUSSION OF RELATED ART

A pillow generally provides cushioning for the head and neck, typically in a laying position. A travel pillow, conversely, needs to be designed to provide firm support for the neck to prevent the person's head from dropping forward or back or falling to one side or another. A travel pillow must support the person's neck usually while in a vehicle in motion and often while seated through a range of angles from seated upright to fully reclining horizontally, as is common during long automobile, train, boat and airplane trips. Prior embodiments of the art have not generally provided adequate support for the neck and have instead focused on a “U” shaped pillow that is adapted to fit around the neck of a person atop the person's shoulders. These “U” shaped travel pillows provide an effective design for staying on the user's shoulders and provide cushioning for the head and neck. But the “U” shape can easily result in neck strain caused by the pillow pushing the user's head forward and these “U” shaped pillows often promote discomfort by failing to adequately support and immobilize the user's neck front to back and side to side.

U.S. Utility patent application Ser. No. 13/488,443, filed by Sternlight et al., on Jun. 4, 2012, describes a U shaped travel pillow with a wider base and a tapering, contoured upper portion intended to provide additional support for the user's neck. This device has a removable, reversible cover; pockets for devices and spaces for headphones; a drawstring or other method for connecting the ends and may be made of memory foam. While this invention may provide cushioning for the head, because it is wider at the base and because of its U shape, this travel pillow will force the person's head forward, causing neck strain, as there is little or no support in the front. The side and rear lobes, moreover, are not tall enough, and the lobes will not adequately support one's head if it falls left, right, back, or forward.

U.S. Pat. No. 8,289,538 filed by Fidge on Sep. 18, 2001 describes a travel pillow that extends from one of the user's shoulders to the user's respective ear and that can be varying in size and can be attached on one side of the person's head or the other with an elastic strap or positioning scrim. While this invention may cushion the head and provide some support on the side of the neck it is under, because of its placement on only one shoulder or another, this device does not provide adequate support for the other side of the neck or on the other front to back axis. This devices lacks the ability to control the user's motion both front to back and side to side at the same time.

U.S. Pat. No. 5,230,349 to Silver et al. on May 15, 2001, describes a travel pillow having a compact size and U-shape for cradling the head and neck of a user while sitting. This device is adapted to allow the user to remove fill material in order to adjust firmness. While this invention is capable of providing cushioning for the head, it does not provide adequate neck support in left, right, and forward positions.

U.S. Pat. No. 4,345,347 to Kantor on Aug. 24, 1982, describes a cushion having a U-shaped portion for supporting the head and neck of a user while sitting. This device adapted to accept a sleeve to cover parts of the cushion that will touch skin or hair, and includes weights for balancing the device on the shoulders. While this invention is capable of providing neck support, it does not provide adequate neck support in left right, and forward positions and is not adapted to prevent an extreme forward head position.

U.S. Pat. No. 98,859 to Fast on Jan. 18, 1870, describes a travel pillow having a cushion for promoting the comfort of passengers white traveling. This device comprises an inflatable semi-circular cushion and a strap adapted to form the cushion around the neck by applying downward force with the arms. While this invention is capable of providing neck support it does not provide adequate neck support in left, right, and forward positions and is not adapted to prevent an extreme forward head position. While several travel pillows exist in the prior art, few provide adequate support for alternative head positions. Furthermore, travel pillows are notorious for forcing the head forward, causing neck strain. Finally, current travel pillows do not adequately support a front position due to the gap of the “U” shape. Therefore, there is a need tor a travel pillow that can provide adequate neck support for all head positions without causing undue strain. Furthermore, a need exists for a travel pillow that will not force the head forward in a rearward position. The present invention accomplishes these objectives.

### SUMMARY OF THE INVENTION

The present invention discloses a travel pillow comprising a C-shaped or when closed and in use an O-shaped, thinner stiff or rigid base collar with a second C-shaped, fuller and softer raised cushion fixed to the top side of the base collar. The walls of the base collar are tapered and shaped to fit snugly around the person's neck and beneath the person's chin and are cushioned and fabric covered, providing a breathable, comfortable, supporting surface for the neck. Furthermore, the top cushioned portion is filled with a gas, liquid, pellets, beans, foam or padding that flows or can be shifted within the cushion for an improved fit against the multitude of possible surfaces found during travel, such as a headrest seat, or chair. The top cushioned portion is thicker but softer than the bottom collar portion, providing more liberty to adjust head position by easily adapting to the shape of the headrest, seat or chair. The bottom collar portion is longer on both ends than the top cushioned portion and the bottom collar portion ends in hook and loop straps, buckles and straps, laces, buttons, snaps, zippers, drawstrings or any similar mechanism that allows the bottom collar portion to be overlapped and attached around the person's neck. A removable cover is adapted to cover the base collar and the top raised cushioned portion. The cover may further be reversible, where the outside of the cover has a contrasting appearance to the inside of the cover. This travel pillow is ergonomically designed so that the collar fits securely around the neck providing the person's head with complete support in all directions and the top pillow cushions the head of the user and forms to the seat back, without pushing the user's head forward.

The raised cushioned portion is ergonomically designed to comfortably fit around the neck without causing undue strain. Furthermore, the raised cushioned portion is adapted to accommodate a person wearing headphones. Pockets can be positioned on the outside and bottom of the base collar or the top cushioned portion for storing electronic devices and other objects.

The travel pillow is generally intended to provide support to the neck and to cushion the head while traveling. As such, the base collar is formed from a rigid plastic, foam, expanded polystyrene or any other similar material and is covered with a thinner padding or cloth covering designed to be soft and comfortable against the person's skin and have breathable characteristics to provide adequate ventilation. This base collar is designed to be attached securely around the person's neck and fastened beneath the person's chin with straps ending in hook and loops, buckles, buttons, snaps, laces, zippers or other similar mechanism for attachment. The top cushioned portion that is fuller, softer and shorter than the collar is designed to fit around the person's head on either side of, or under the chin, across both cheeks, around the ears and the back of the head. The top cushioned portion is filled with a gas, liquid, pellets, beans, formed from memory foam material, padding, or similar material that provides a cushion that flows or adapts to the shape of the person's head and the seat they are seated in comfortably, cushioning the head and, providing adequate ergonomic support to the neck, even when seated in an upright position. The travel pillow can be shaped like an animal, character, or sports team logo.

The present device is a travel pillow that can provide adequate neck support for ail head positions Without causing undue strain. Furthermore, a need exists for a travel pillow that will not force the head forward or allow the head to fall in a rearward position. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view showing one embodiment of the invention in use;

FIG. 2 is a front, elevation view of the embodiment closed as it would be worn in use;

FIG. 3 is an overhead view thereof;

FIG. 4 is a rear elevation view thereof;

FIG. 5 is a bottom view thereof;

FIG. 6 is a front elevation view of the embodiment open, pending attachment around the person's neck.

### DETAILED DESCRIPTION OF THE PREFERRED EMBODIMENT

Illustrative embodiments of the invention are described below. The following explanation provides specific details for a thorough understanding of and enabling description tor these embodiments. One skilled in the art will understand that the invention may be practiced without such details. In other instances, well-known structures and functions have not been shown or described in detail to avoid unnecessarily obscuring the description of the embodiments. Unless the context clearly requires otherwise, throughout the description and the claims, the words “comprise” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

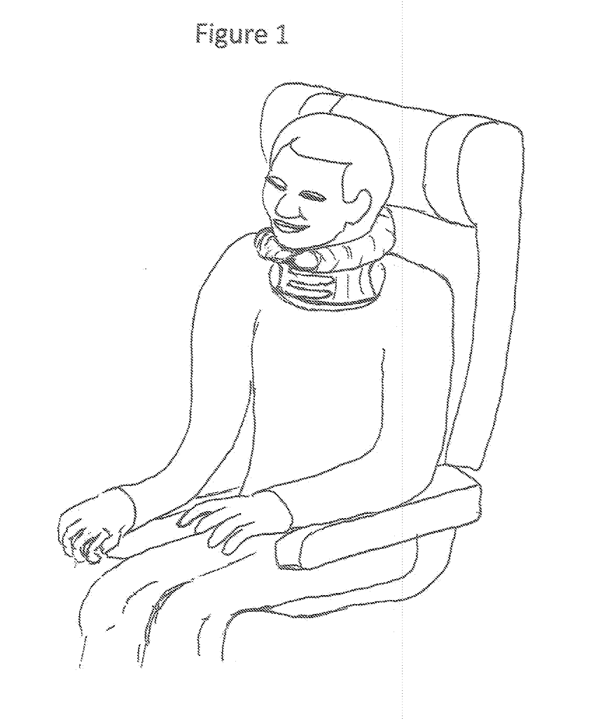

FIG. 1 illustrates an embodiment of the present invention for a travel pillow in use being worn around The user's neck.

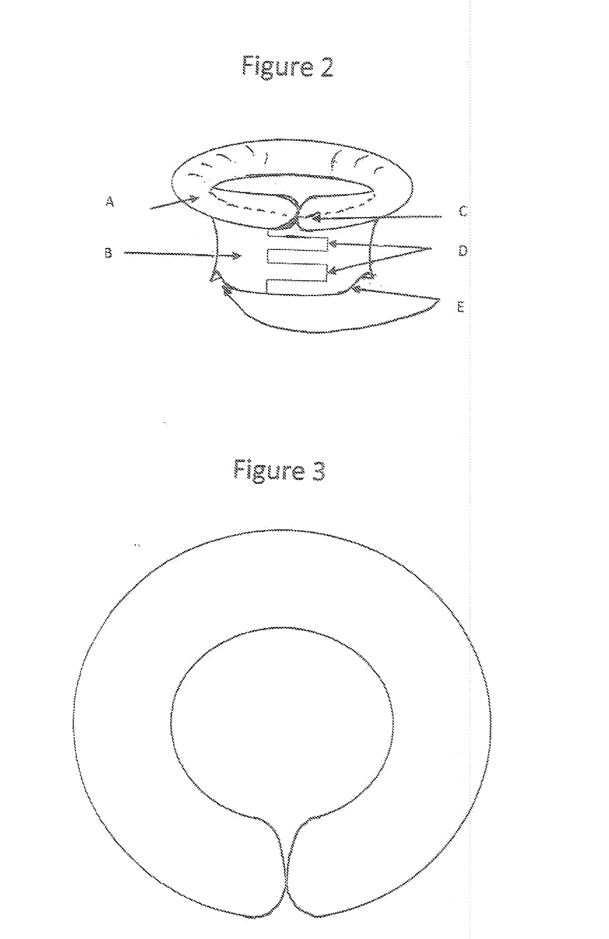

FIG. 2 illustrates an embodiment of the present invention in the closed position as it would be used worn around the person's neck. (A) is the larger, fuller, softer and shorter cushioned top that is designed to fit comfortably around the person's head, across both cheeks and beside or beneath the person's chin depending on their preference for comfort and stability, which is filled with shy flowing or shifting fill material for better contact with irregular surfaces such as the back of a train seat or inside of an airplane cabin and covered in a breathable fabric that is attached to: (B) the thinner, stiffer, longer bottom collar made of a rigid plastic or foam and covered with a soft breathable cushion or fabric which is contoured to fit the shape of a person's neck. (C) illustrates with a dotted line the ergonomically contoured top edge of the bottom collar designed to fit beneath the person's chin. (D) indicates the straps ending in hook and loop means of attachment at the end of the bottom collar that are used to fasten the embodiment securely around the person's neck. (E) illustrates the contoured edges on either side of the bottom edge of the collar which are economically shaped to fit over the person's shoulders.

FIG. 3 illustrates an overhead view of the embodiment when closed as it would be worn around a person's neck.

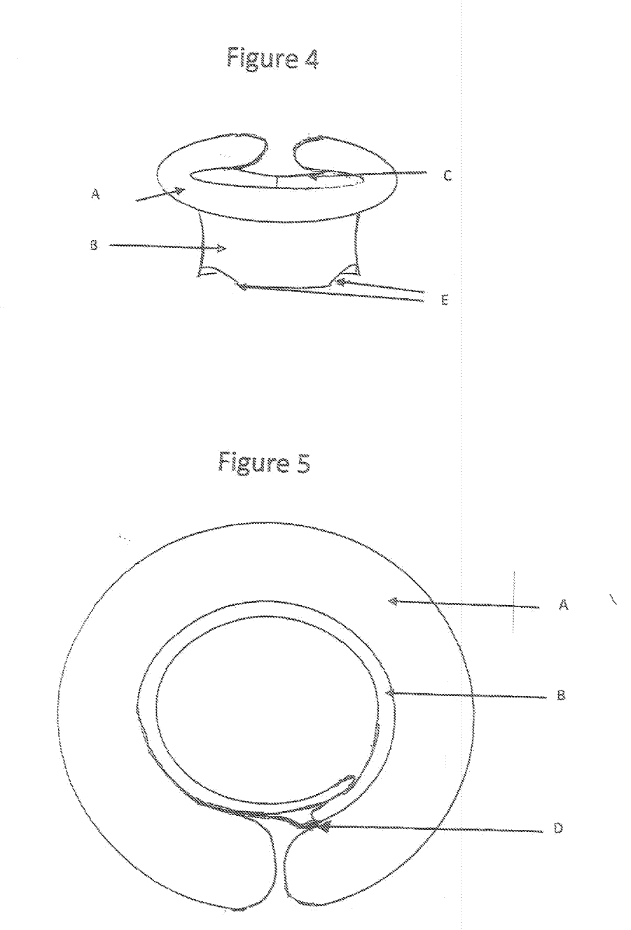

FIG. 4 illustrates a rear elevation perspective of the embodiment when closed as it would be worn around a person's neck. (A) is the fuller top cushioned portion attached to (B) the thinner rigid collar. (C) shows the curved top edge of the bottom collar that is designed to fit beneath the person's chin and (E) illustrates the economically shaped bottom edge of the collar that is curved on each side to fit over the curve of the person's shoulders.

FIG. 5 illustrates an underneath view looking up at the bottom of the embodiment as it would be seen if in use. Herein, (A) is the fuller top cushioned portion attached to (B) the thinner rigid collar. (D) illustrates the hook and loop straps that firmly secure the embodiment around the person's neck.

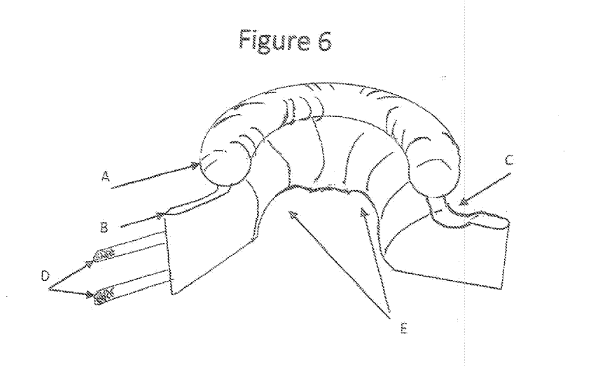

FIG. 6 is a front elevation view of the embodiment open, pending attachment around the person's neck. (A) is the fuller top cushioned portion attached to (B) the thinner rigid collar, (C) shows the curved top edge of the bottom collar that is designed to fit beneath the person's chin (D) illustrates the hook and loop straps that firmly secure the embodiment around the person's neck. (E) illustrates the ergonomically shaped bottom edge of the collar that is curved on each side to fit over or around the curve of the person's shoulders.

A selectively removable fabric cover is adapted to cover the base and raised cushion. In one embodiment, the fabric caver is reversible, where a first side of the cover has a different appearance than the second side of the cover. In an alternative embodiment, the base collar and the raised cushion are selectively mutually detachable by an attachment mechanism such as a zipper (not shown), two-part hook-and-loop type material, button, snap and/or laces. As such, the fabric cover is adapted to cover the base cushion, while a second fabric cover is adapted to cover the raised cushion. The fabric cover may be machine washable, so as to allow for cleaning of the cover.

The raised cushion may include a pair of opposing recesses (not shown) or semicircular cut-outs (not shown) on the inner peripheral wall of each side, whereby the raised cushion does not interfere with a person wearing headphones. Furthermore, the outer peripheral wall of the top cushion may include at least one pocket (not shown) for holding an item. In an alternative embodiment, the bottom side of the base collar may further include at least one pocket (not shown) for receiving a second item. The raised cushion or bottom collar may include a clip, hoop, strap, or other means (not shown) of convenient attachment to a person's luggage or clothing.

The top cushion of the travel pillow is generally intended to provide cushioning for the head that is adaptable to the many surfaces and shapes encountered while traveling. As such, it is ideally filled with any shifting or flowing material such as foam beads or a gel although any similarly suitable shifting or flowing material may be substituted. Other materials include fabrics, polyester, grains, aromatherapy material, fluids, liquids or a gas such as air. The base collar, in one embodiment, is integrally formed from a thermo shaped or molded plastic material that is covered with a thin foam, cloth or fabric shaped to fit securely, yet comfortably, around the neck, providing adequate ergonomic support to the head when seated in an upright position or at any other angle. In the preferred embodiment, the approximate device overall dimensions are 5″-8″ in height×3″-5″ wide×14″-22″ long, although any suitable size or material may be used.

While a particular form of the invention has been illustrated and described, it will be apparent that various modifications can be made without departing from the spirit and scope of the invention. For example, an electrical heating and massaging device may be incorporated to provide heat and massage to the neck. Additionally, the travel pillow 10 may be shaped like an animal, cartoon character, sports team logo, article of clothing or other novelty shape. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention. The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference.

Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

PATENT CITATIONS

| Cited | | Publication | | |
|---|---|---|---|---|
| Patent | Filing date | date | Applicant | Title |
| US98859 | | Jan. 18, 1870 | | Improved |
| | | | | travelling- |
| | | | | sleeping- |
| | | | | cushion |
| U.S. Pat. No. 4,345,347 | Apr. 24, | Aug. 24, 1982 | Kantor Philip A | Head and |
| | 1980 | | | neck support |
| | | | | cushions |
| U.S. Pat. No. 6,230,349 | May 3, | May 15, 2001 | Abbye M. | Travel pillow |
| | 2000 | | Silver | |
| U.S. Pat. No. 6,289,538 | Dec. | Sep. | Figde | Varriable |
| | 19, 1999 | 18, 2001 | | Contour Head |
| | | | | Support |
| U.S. Pat. No. 8,144,913 | Jan. 23, | Mar. 27, 2012 | Myles Jr | Travel pillow |
| | 2008 | | Robert L | with audio |
| | | | | system |
| USD619402 | Jan. 15, | Jul. 13, 2010 | David Bret | Travel pillow |
| | 2010 | | Sternlight | |

What is claimed is:

1. A travel pillow comprising: a C-shaped or an O-shaped thinner cushioned and slightly flexible but stiff closable collar having a top which is a thicker softer padded or cushioned portion with an outer peripheral surface, forming a circular or C shape that when worn forms a round donut or O shape around the person's neck. The bottom of the raised cushioned portion fixed with the top side of the base collar, the wall of the collar being thinner, stiffen ergonomically contoured to fit the shape of the person's neck and the length being longer and ending in a mechanism allowing adjustable attachment around the person's neck;

2. The travel pillow of claim 1 wherein the inner peripheral wall of the collar extends below the outer peripheral wall of the raised cushioned portion.

3. The travel pillow of claim 1 wherein the outer peripheral top of the collar and the bottom of the raised cushioned portion are mutually flush.

4. The travel pillow of claim 1 wherein the front top side of the collar has a depression to fit beneath the person's chin.

5. The travel pillow of claim 1 wherein any portion is filled with any shifting or flowing gas, liquid, memory foam, pellets, bean, padding or other similar material.

6. The travel pillow of claim 1 wherein any portion is filled with any heat or cold developing or retaining material, endothermic or exothermic reaction, or other thermoconductor.

7. The travel pillow of claim 1 further including any mechanism for attaching the collar portion securely to itself around the person's neck including but not limited to hook and loop, buttons, snaps, zipper, laces, drawstring, etc.

8. The travel pillow of claim 1 wherein any portion hoops, indentations, pockets, wire runs or similar means are incorporated to accommodate a person wearing headphones.

9. The travel pillow of claim 1 wherein any portion of the outer surface wall of the collar or cushion includes at least one pocket for holding an item.

10. The travel pillow of claim 1 wherein the collar attachment mechanism may be adjusted until the collar portion overlaps around the person's neck.

11. The travel pillow of claim 1 wherein the base collar Is formed of any stiff or rigid material such as heat formed or molded plastic or other similar material coated with or lined with any softer padding such as foam, fabric, fleece, fur, cloth, or other similar material.

12. The travel pillow of claim 1 wherein the fabric cover is removable.

13. The travel pillow of claim 1 wherein the fabric cover is reversible, and the inside of the cover has any different color, texture or appearance than that of the outside of the cover.

14. The travel pillow of claim 1 wherein the collar portion and the raised cushioned portion are mutually detachable by any common attachment mechanism such as hook and loop, zipper, snap, button, laces, or other similar mechanism, and wherein the fabric cover is adapted to cover the base collar, and wherein a second fabric cover is adapted to cover the top cushioned portion.

15. The travel pillow of claim 1 wherein any portion is designed to resemble an animal, sports logo, character or article of clothing.

16. The travel pillow of claim 1 wherein any portion is designed to be a clip, loop, hook, latch or other similar mechanism for conveniently attaching the same to a piece of luggage or article of clothing.

17. The travel pillow of claim 1 wherein the fabric cover is made of a breathable or wicking material designed to efficiently move moisture away from the person's skin.

18. The travel pillow of claim 1 wherein the bottom edges of the collar are ergonomically curved to accommodate the curvature of the person's shoulders.
